(19) United States
(12) Patent Application Publication
(10) Pub. No.: US 2007/0005621 A1
(43) Pub. Date: Jan. 4, 2007

(54) Information system using healthcare ontology

(76) Inventors: Kathryn Ann Lesh, Takoma Park, MD (US); Ralph Laguerre, Laurel, MD (US)

Correspondence Address: VOLENTINE FRANCOS, & WHITT PLLC, ONE FREEDOM SQUARE, 11951 FREEDOM DRIVE SUITE 1260, RESTON, VA, 20190, US

(21) Appl. No.: 11/141,321

(22) Filed: Jun. 1, 2005

(51) Int. Cl. G06F 7/00

(52) U.S. Cl. 707/101

(57) ABSTRACT

An information system using a healthcare ontology to provide a standardized representation for healthcare data is disclosed. One embodiment of the information system comprises a digital logic platform storing and using the healthcare ontology. The healthcare ontology describes concepts and relationships between the concepts derived from the corpus of domain specific knowledge and linking with standardized terminological systems.

This application is related to commonly assigned U.S. patent application Ser. Nos. 11/034,936; 11/034,937; 11/034/961; and 11/034,962 concurrently filed on Jan. 14, 2005, the collective subject matter of which is hereby incorporated by reference.

### BACKGROUND OF THE INVENTION

1. Field of the Invention

The invention relates generally to an information system for processing healthcare data. More particularly, the invention relates to an information system using a healthcare ontology to provide a standardized representation for healthcare data.

2. Description of the Related Art

Healthcare professionals, including physicians and nurses among others, spend a significant amount of their time dealing with administrative tasks. These tasks include, for example, documenting patient encounters and treatment plans, reviewing lab/treatment results, submitting billing records, and preparing healthcare insurance information. Unfortunately, time spent on administrative tasks tends to detract from patient care, it drives up the cost of healthcare, and in many cases it leads to inaccurate and hastily put together reports, records, and so forth.

One of the goals of modern healthcare is to automate as many healthcare-related administrative tasks as possible using technology, thereby freeing up healthcare professionals to attend to patients, reducing the overall cost of healthcare, and ensuring that the administrative tasks are done in a standardized and accurate way. An important aspect related to the automation of healthcare-related administrative tasks is providing standardized representations for healthcare-related data. Standardized representation(s) form a logical framework that allows the efficient capture, structuring, manipulation, and similar processing of data in order to facilitate further automated procedures related, for example, to the use and/or interpretation of the healthcare-related data.

One such representation is provided by an ontology. The general concept of an ontology is discussed in some additional detail in the above cited U.S. patent applications. In addition, a great body of literature is dedicated to the description of ontologies, including their various properties and uses. Briefly, an ontology describes concepts and relationships that may exist within a specific domain of knowledge. In other words, the ontology is a conceptualization specification for that particular domain of knowledge.

Because the field of healthcare is rife with interrelated conceptual distinctions, an ontology seems like an natural way to represent healthcare-related information. However, the exceedingly complex and interrelated nature of the healthcare-related concepts poses a great challenge to the definition, formulation and use of related ontologies. The definition of healthcare-related concepts implicates the enormous effort required to disambiguate the meaning of terms (e.g., words and phrases) depending on their scope and context of usage. For example, the term “COLD” as used by a physician in a clinical setting could be taken to indicate a temperature, a physical sensation, a mood or feeling, a commonly occurring viral infection, or Chronic Obstructive Lung Disease. Further, relationships between healthcare-related concepts can be extremely difficult to disentangle. For example, a single symptom or set of symptoms may be associated with more than one medical condition. Also, a particular symptom associated with a certain medical condition in one context may not be associated with that medical condition in another context.

In addition to effectively representing the rich and complex conceptual landscape associated with healthcare-related information, a competent healthcare-related ontology should also provide a representation that lends itself to subsequent processing and interpretation of related healthcare data using various industry standards including, for example, various terminological systems defining standard healthcare-related concepts and so forth.

### SUMMARY OF THE INVENTION

According to one embodiment of the invention, an information system is provided comprising a digital logic platform storing a healthcare ontology. The healthcare ontology comprises concepts derived from a domain specific corpus of knowledge linked to at least one standard selected from a group of standards consisting of, but not limited to the Systematized Nomenclature of Medicine Clinical Terms (SNOMED CT), Current Procedural Terminology (CPT), International Classification of Diseases, 9^{th} Revision, Clinical Modification (ICD-9-CM), Medical Subject Headings (MeSH), Logical Observations, Identifiers, Names, and Codes (LOINC), Computer Retrieval of Information on Scientific Projects (CRISP), Center for Disease Control and Prevention (CDC) web redesign thesaurus, Evaluation and Management (E&M) codes, and RxNorm, a standardized nomenclature for clinical drugs.

According to another embodiment of the invention, a method of forming a healthcare ontology is provided. The method comprises identifying a purpose for the ontology, choosing a design approach for the ontology, identifying concepts, components, and conventions for the ontology, constructing the ontology, and maintaining the ontology. Concepts are identified by extracting concepts from a domain specific corpus, matching the extracted concepts with concepts contained in a standard library, and performing concept matching on the extracted concepts, thereby establishing semantic relationships.

According to still another embodiment of the invention, a method of using a healthcare ontology is provided. The method comprises receiving a file and accessing a domain specific ontology, extracting concepts from the file, and outputting a standardized representation for the concepts based on the domain specific ontology. The standardized representation comprises an architecture indicating specific relationships between the concepts. In some cases, the standardized representation can be used to generate billing codes.

### BRIEF DESCRIPTION OF THE DRAWINGS

Exemplary embodiments of the invention are described below with reference to the accompanying drawings. Throughout the drawings like reference numbers indicate like exemplary elements, components, or steps. In the drawings:

FIG. 1 is a broad conceptual illustration of one embodiment of the invention;

FIG. 2 is a flowchart illustrating an exemplary method of developing an ontology;

FIG. 3 is an illustration of a top down concept hierarchy for an exemplary healthcare ontology;

FIG. 4 is a flowchart illustrating an exemplary method of concept matching;

FIG. 5 is a flowchart illustrating an exemplary method of concept mapping;

FIG. 6 is a diagram of a system incorporating an ontology development tool;

FIG. 7 is a diagram of a system using a domain specific ontology to produce a standardized output; and,

FIG. 8 is a conceptual diagram illustrating a composite ontology comprised of multiple linked domain specific ontologies.

### DESCRIPTION OF EXEMPLARY EMBODIMENTS

The invention addresses the general need for more effective ways of managing the massive amounts of data that healthcare professionals are forced to deal with on a constant basis. In this regard, embodiments of the invention provide an information system using a healthcare ontology to produce a standardized representation for healthcare-related data.

The term “healthcare data” is used to broadly refer to any data resulting from, referenced in relation to, or characterizing interactions between a healthcare professional and another entity (e.g., a patient, another healthcare professional, a hospital, medical facility, or insurance company, etc.). Sources of healthcare data include, as selected examples, patient healthcare records, billing records, laboratory orders and results, treatment plans and results, medication orders, healthcare insurance information, and medical or scientific literature.

Consistent with the foregoing background discussion of ontologies, a “healthcare ontology” is a conceptualization specification for one or more domains of knowledge related to human or animal health. Thus, the term “healthcare” in this context broadly encompasses knowledge domains including, for example, medicine, nursing, healthcare procedures, medical evaluations, diet, nutrition, exercise, wellness, disease prevention, etc. However, the term “healthcare” in the context of the invention is not limited to only knowledge domains directly related to information resulting from, referenced in relation to, or characterizing interactions between a healthcare professional and another entity. Rather, information collaterally related to interactions between a healthcare professional and another entity is also subsumed in the definition of healthcare. Billing information is an excellent example of such collaterally related information. It does not directly result or arise from an interaction between a healthcare professional and a patient. That is, the healthcare professional and patient do not negotiate, and rarely discuss an applicable schedule of fees during an office visit. However, the accurate generation of billing data related to the office visit, regardless of patient outcome, is integral to the success of the office visit.

Of note, the foregoing discussion is couched in terms of an office visit example. This is a commonly understood context and will be used in various examples that follow to illustrate the utility, making, and using of the invention. However, this common teaching example should not be interpreted as communicating the entire breadth and range of application for the invention. Any number of similar examples might be used to explain the invention, including for example, a veterinary procedure, a physical therapy session, a school wellness screening, a medical research study, etc.

The healthcare data noted above is often “non-standard” in its original (or originating) form. That is, it potentially suffers from one or more ambiguities in use, definition, and/or expression.

In contrast, the term “standardized representation” denotes a structured form of healthcare data generated in accordance with one or more established criteria. A standardized representation can exist in either virtual or physical space. For example, the standardized representation may be a data structure stored in a digital logic device or memory, an image displayed on a screen, a paper printout, etc. Where the standardized representation comprises a data structure, It may have any competent structure, format, or form, including a compressed or otherwise abbreviated data format as well as tagged or similarly enriched data fields.

The form of the standardized representation is not necessarily restricted by the healthcare ontology used to produce it. For example, the structured representation need not always preserve relationships between concepts identified or traversed in the healthcare ontology. This having been said, however, at least one embodiment of the invention recognizes certain benefits of using a standardized representation that preserves concepts and relationships described by the healthcare ontology. This particular approach results in a data representation that is highly susceptible to further processing (e.g. interpretation, modification, comparison, etc.) using conventional techniques or external systems and/or applications. Thus, a standardized representation that preserves the concepts and relationships described by the healthcare ontology may be particularly useful in the generation of various types of healthcare related reports such as billing reports, patient health records, epidemiological reports, etc.

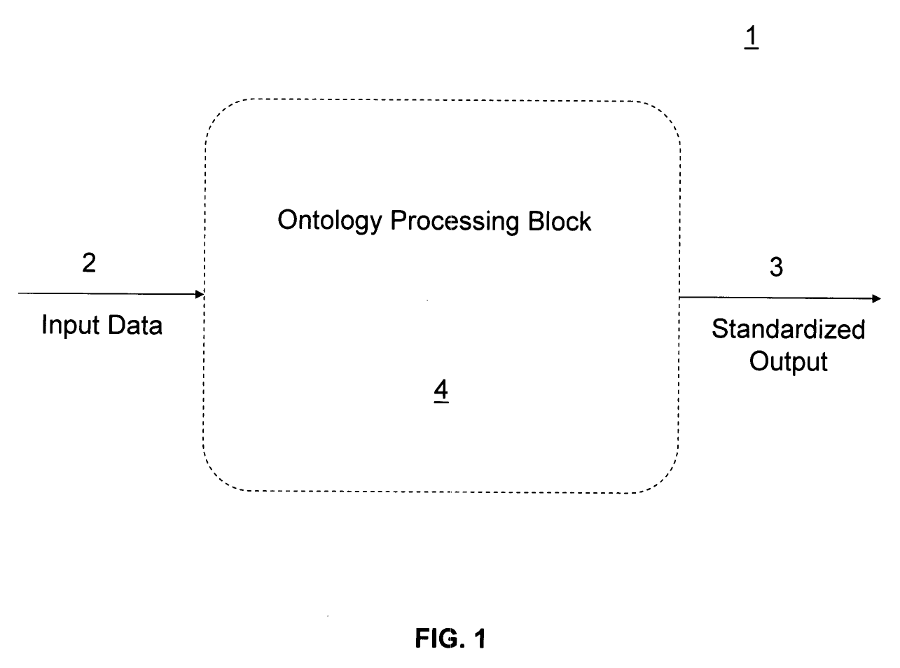

One embodiment of the invention is generally and conceptually illustrated in FIG. 1. As shown in FIG. 1, an information system 1 adapted to provide a standardized representation for healthcare data comprises an ontology processing block 4. Ontology processing block 4 receives input data 2 and generates a standardized output 3.

The term “block” as used above refers to any arbitrary or prescribed conceptual distinction made regarding functional characteristics of the invention. In other words, ontology processing block 4 may be embodied in various forms and configurations, including as examples; independent hardware module(s) and/or software application(s), a middleware application, part of a distributed system or network, part of a hybrid hardware/software application, etc. In a related aspect, ontology processing block 4 is adapted to communicate with various other functional “blocks” in a larger system. For example, one or more pre-processing functions enabled by one or more pre-processing blocks (not shown) may be applied to input data 2 prior to its application to ontology processing block 4. Similarly, one or more post-processing functions enabled by one or more pre-processing blocks (not shown) may be applied to standardized output 3 following operation of ontology processing block 4.

As used above, the term “processing” should be read to broadly cover any combination of hardware and/or software functionality capable of implementing data manipulation, transfer or conversion operations, as well as any logical, mathematical, or access operations necessary to accomplish the design of ontology processing block 4. Signal and/or data processing may in some embodiments be accomplished by a “digital logic platform” including, for example, a microprocessor, a digital logic unit or processor, a micro-controller, a programmed logic array, a state machine, or similar computational hardware and associated memory. (Hereafter, these conventional elements are generally referred to separately and/or collectively as “computational logic and memory”). Several examples of possible digital logic platforms will be described in some additional detail hereafter.

Regardless of the specific nature of the digital logic platform, it will run one or more applications enabling aspects, features, or functionality associated with an embodiment of the invention. The term “run” is used in the broad context normally associated with software execution on a hardware platform. An “application” is any portion of software code enabling at least in part one function. A “subroutine” is generally used to describe some portion of software code less than an entire application, but those of ordinary skill in the art will understand that any body of software may be arbitrarily partitioned in many ways to produce multiple applications, multiple subroutines, and/or multiple applications each having multiple subroutines. Nonetheless, reasonable effort has been expended here to describe exemplary embodiments coherently. So, terms such as “application” and “subroutine” have been used to illustrate possible relationships. Yet, in the end, it is all “software” subject to great variation in design and implementation.

Ontology processing block 4 of FIG. 1 performs at least one function; it applies a healthcare ontology to input data 2 in order to generate standardized output 3. A description of an exemplary healthcare ontology and its manner of use is given hereafter.

Like other ontologies, the exemplary healthcare ontology contemplated in one embodiment of the invention is generally defined by: (1) hierarchically linking concepts in order to form a taxonomy (e.g., using “IS-A” relationships to link concepts); (2) populating the taxonomy with specific terms (e.g., words, and/or phrases) synonymous to the linked concepts; and, (3) enriching the populated taxonomy with higher order relationships (e.g., relationships such as, “IS-PART-OF”, “MAPS-TO”, “INTERACTS-WITH”, etc.). Many specific design choices will be made by a healthcare ontology designer These design choices generally depend on and flow from the potential application(s) of the healthcare ontology, as well as the designer's understanding and/or definition of the domain.

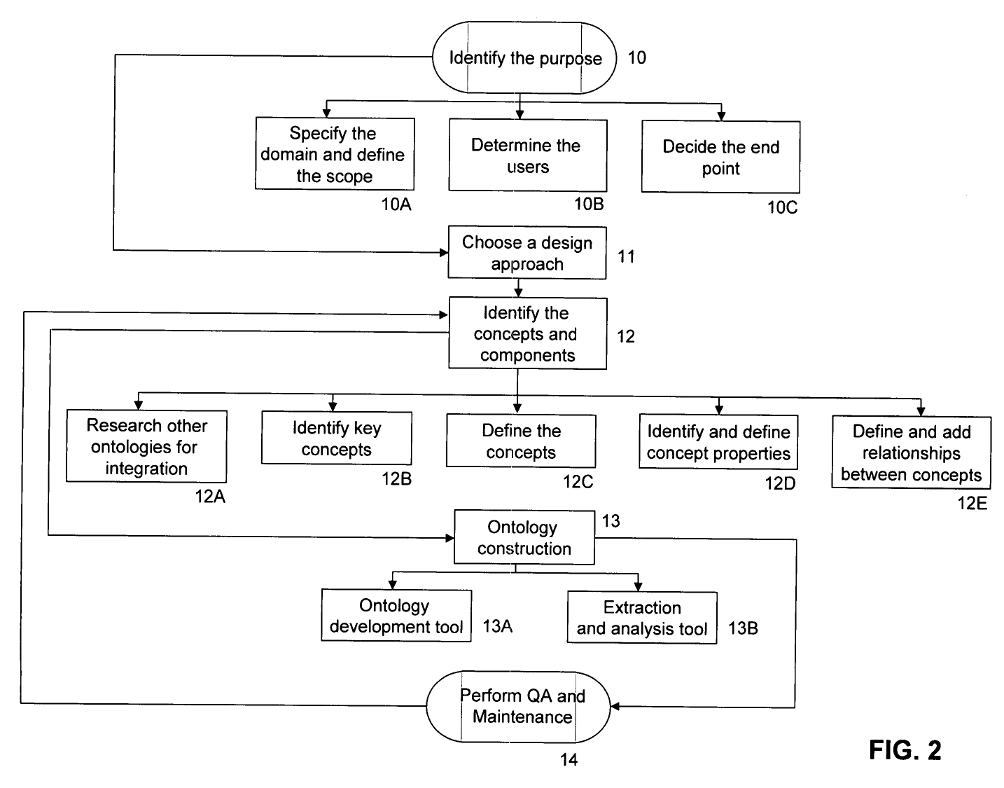

FIG. 2 illustrates one exemplary embodiment of a method adapted to the formation of a healthcare ontology. The exemplary flowchart shown in FIG. 2 is explained in a broader sense in commonly assigned and pending U.S. patent application Ser. No. 11/034,936 filed Jan. 14, 2005 which was previously incorporated by reference.

For purposes of this explanation, the broad example presented in the referenced application is further refined to illustrate an exemplary method adapted to the formation of a competent, and more specific, healthcare ontology. This more specific example is drawn to a healthcare ontology related to the disease Diabetes Mellitus (hereafter referred to for the sake of simplicity as “diabetes”, recognizing that many forms of diabetes exist within the healthcare field). The resulting exemplary ontology will be referred to hereafter as the “diabetes ontology.”

In accordance with the exemplary method illustrated in FIG. 2, the diabetes ontology may be formed using five (5) general steps, including: identifying the ontology's purpose (10), choosing a design approach for the ontology (11), identifying concepts, properties (i.e., characteristics), and conventions (12), constructing the ontology (13), and maintaining the ontology (14).

In this example, the resulting ontology is intended to create a logical framework for capturing, structuring, and formalizing knowledge pertaining to a domain of interest—diabetes. In order to create this logical framework, an appropriate domain and scope for the diabetes ontology must be determined. At a minimum, this step entails defining the set of concepts, and relationships between the concepts that will be covered by the diabetes ontology.

Like all ontologies, the domain and scope of the diabetes ontology will depend on how the ontology is to be used, who and/or what will be end users of the ontology, and what types of questions will be answered through use of the ontology (10A). These questions can be answered, wholly or in part for example, by consulting with domain experts. For diabetes, potential domain experts include; patients with diabetes and their care-givers, internal medicine specialists, nurses, ophthalmologists, endocrinologists, podiatrists, medical researchers, dietitians, insurance companies, certified diabetes educators and/or similarly interested parties.

With or without the use of domain experts, the scope of the diabetes ontology may be defined, or further defined, in relation to a range of questions that the ontology is intended to answer. For example, should the diabetes ontology describe information relating to selected subcategories of services involved in or implicated by a particular patient encounter? Should the diabetes ontology describe the social, family, or personal history of the illness, etc?

The domain and scope of the diabetes ontology may be further refined using information provided by an existing healthcare databases or other related terminological systems, including, as selected examples, the Systematized Nomenclature of Medicine Clinical Terms (SNOMED CT), Current Procedural Terminology (CPT), International Classification of Diseases, 9^{th} Revision, Clinical Modification (ICD-9-CM), Medical Subject Headings (MeSH), Logical Observations, Identifiers, Names, and Codes (LOINC), Computer Retrieval of Information on Scientific Projects (CRISP), Center for Disease Control and Prevention (CDC) web redesign thesaurus, Evaluation and Management (E&M) codes, and/or RxNorm, a standardized nomenclature for clinical drugs. In this regard, the domain and scope of the diabetes ontology may be further defined in relation to inter and/or intra concept relationships described in existing databases and terminological systems. These concepts and concept relationships may be derived by the ontology development team, possibly including domain experts, using manual and/or automated processes such as data and/or text mining.

In addition to defining the diabetes ontology's domain and scope, potential users of the diabetes ontology are determined (10B). In the working example, healthcare professionals, including at least nurses and physicians, will be likely users of an information system incorporating the diabetes ontology. Further, the information system is most likely to be used in a clinical setting (e.g., a setting where the healthcare professional interacts directly with another entity, such as a patient). In this context, the healthcare professionals will use the capabilities provided by the diabetes ontology as a framework for capturing, structuring, and formalizing knowledge related to such interactions.

The last exemplary aspect of identifying the diabetes ontology's purpose described here involves a decision on appropriate end points (10C). A likely end point for the working example is one wherein the diabetes ontology is able to extract and/or define knowledge from input data. In one related embodiment, this end point is achieved by extracting concepts from an input data file and automatically mapping input concepts to SNOMED CT and/or ICD-9-CM concepts using an application running on a digital logic platform. Where an automated procedure is used to arrive at this end point, the accuracy of the automated procedure will typically be validated and/or adjusted in relation to various test scenarios or modeling exercises.

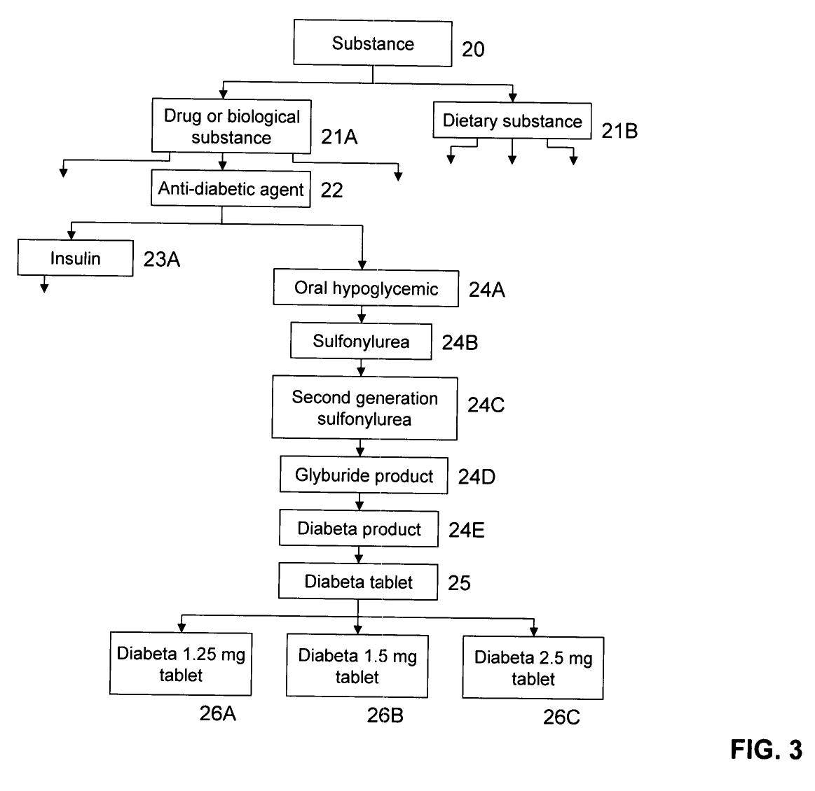

In the second general step described in relation to the embodiment illustrated in FIG. 2 a design approach is chosen (11). For example, in the working example of the diabetes ontology, the ontology development team may decide to use a “top-down” design approach to create a concept hierarchy for the ontology. An exemplary concept hierarchy is illustrated in FIG. 3.

For purposes of this explanation, it is assumed that the concept hierarchy shown in FIG. 3 results from an ontology development team's efforts to search for and analyze diabetes-related concepts identified in various standard healthcare terminological systems. By choosing a top-down design approach for this particular hierarchy, the ontology development team determines to generally order the resulting hierarchy in such a manner that parent concepts are broader than their respective child concepts. The top down design approach is particularly beneficial in the creation of a hierarchy representing data at varying, finite levels of detail. For example, a hierarchy created using a top down design approach might be used in the creation of the diabetes ontology that generally follows a common interview approach to capturing data during interactions between a healthcare professional and a patient. That is, general questions regarding the patient's overall health ultimately generate more specific inquires and corresponding responses having increasingly finite detail. Naturally, the level and type of detail described by such interactions will vary according to the healthcare professional's specialization, the type of patient and interaction, etc.

Other design approaches might be variously applied in addition to or in the alternative to a top down design approach. For example, a bottom up design approach, a clustering design approach, or some combination of these approaches may be used. The exemplary hierarchy shown in FIG. 3 is described below in the context of defining a particular concept.

Once a design approach has been selected, concepts and properties are identified and defined (12). Concepts related to diabetes may be identified through the use of domain experts, domain corpora, and/or a search of existing terminological systems, (e.g., SNOMED CT, CPT, ICD-9-CM, E&M, and/or RxNorm), etc. In one particular embodiment, the use of SNOMED CT may provide the basis to underpin the development of the diabetes ontology. Furthermore, SNOMED CT may advantageously used because of its robust concept coverage regarding diabetes and identification as a standard terminological system by the United States National Committee on Vital and Health Statistics.

Additionally or alternatively, the concepts contained in ICD-9-CM may be included or referenced as part of the diabetes ontology. ICD-9-CM includes disease entities, disease code numbers, and a code system for surgical, diagnostic, and therapeutic procedures. ICD-9-CM is used routinely to code and classify morbidity and mortality data from inpatient and outpatient records, interactions between healthcare professionals and patients, etc.

Additionally or alternatively, the concepts contained in CPT may be included or referenced as part of the diabetes ontology. CPT is a list of descriptive terms and identifying codes routinely used to report many services and procedures performed by healthcare professionals.

Similarly, the concepts contained in E&M and/or RxNorm may be included or referenced as part of the diabetes ontology. E&M is an existing classification of services provided by healthcare professionals and is routinely used to generate corresponding billing (e.g., financial and/or accounting-related) codes. RxNorm provides a description of drugs potentially related to diabetes.

Concepts are also identified by a search of additional domain specific source material or by consultation with domain experts or more specifically identified subject matter experts. Indeed, the list of possible concept sources is lengthy and a matter of design choice. However, the process of identifying concepts potentially relevant to the creation of the exemplary diabetes ontology will include one or more of the following general processes or steps: researching other ontologies susceptible to inclusion, reference or integration within the diabetes ontology (12A), identifying key concepts from the corpus of domain specific knowledge (12B), defining a set of agreed upon concepts (12C), identifying concept properties (i.e., characteristics) (12D), and defining and adding relationships between concepts (12E).

During the process of identifying the diabetes ontology's purpose and/or during the process of researching existing databases, related scientific or health literature, and/or ontologies potentially related to the diabetes ontology, one or more key concepts are likely to emerge. A “key concept” is a concept—typically associated with either a noun or noun phrase (e.g. an object) or a verb (e.g., a relationship) that forms part of a necessary or essential part of the framework describing the knowledge domain. A determination of “key” status for a particular concept may be the subject of some debate by the development team and will certainly flow from the purpose ascribed to the diabetes ontology. However, determination of a key concept may be made in light of a set of established criteria, whether subjective and/or empirical. All concepts deemed “key” will be included in the diabetes ontology.

After a set of relevant concepts is identified, each concept in the diabetes ontology is provided with a definition (12C). In some instances, an explicit textual definition is provided for the concept. In other instances, the placement of the concept within the ontology establishes an implied or referenced definition.

For example, consider the partial, top-down hierarchy shown in FIG. 3. Many substances are likely to be implicated or referenced during an interaction between a healthcare professional and a patient. The nature of substance (20) may vary from a dietary substance (e.g., a vitamin, dietary supplement, or food) (21B) to a particular drug or similar biological substance (21A). Anti-diabetic agents, also known as hypoglycemic agents, (22) are one commonly implicated class of drugs. The anti-diabetic agent may be insulin (23A) or an oral hypoglycemic drug (24B). A number of different oral hypoglycemic drugs exist, including original sulfonylurea (24B), second generation sulfonylurea (24C), glybruride product (24D), and Diabeta product 24E of which Diabeta tablet 25 is one particular form. The Diabeta tablet comes in multiple dosages including a 1.25 mg tablet (26A), a 1.5 mg tablet (26B), and a 2.5 mg tablet (26C).

In this context, reference during an interaction between a healthcare professional and a patient to a “1.25 mg Diabeta tablet” has definition and meaning. Movement up/down or laterally through the corresponding hierarchy allows a user (system or person) of the diabetes ontology to glean significant additional related information.

As each concept in the set of relevant concepts has been defined, various concept properties are also identified and defined (12D). Concept properties are domain specific and typically govern how an ontology is presented and structured. For example, concept properties may be used to distinguish and reference each concept as one might reference a software object in an object oriented programming language, or as one might reference a library book using the book's call number. In addition, concept properties may be used to explicitly relate or group concepts having a common purpose or function. Typical concept properties include, for example, a unique identifier for the concept, a visual representation for the concept, explicit definitional or supplemental information about the concept, synonyms, requirements and/or consequences for the concept, status information regarding the concept (e.g. updated, validated, erroneous, speculative, etc.), and access control information for the concept.

Once the concepts are identified and properly defined, relationships between concepts are defined and added (12E). Relationships define logical, contextual, and/or referential connections between concepts. Ontologies generally allow a variety of relationships to exist between concepts and prescribe corresponding connection types. For example the diabetes ontology might allow multiple types of connections to exist, each connection type describing a particular form of relationship, such as; “IS-A”, “HAS-EQUIVALENCE”, “MAPS-TO”, etc.

The “IS-A” relationship is a specific parent-child relationship between two concepts. For ease of explanation, the terms “parent” and “child” will be used to denote this specific relationship. For example, stating that concept X “IS-A” a concept Y, means concept X inherits all the characteristics of concept Y. In other words, the definition of concept X is subsumed by the definition of concept Y. As a more specific example, diabetes is a child concept of the parent concept endocrine-related disorders.

The “HAS-EQUIVALENCE” connection is typically used to define a relationship between a concept and an existing standard terminological system. This type of connection will typically be defined by a synonymous relationship noted between a concept and one or more entries in existing standard terminological systems, as various sources are searched to extract the concepts used to form the ontology. For example, a “HAS-EQUIVALENCE” connection might be defined for a concept Z in relation to one or more entries in SNOMED CT. This connection means concept Z has a synonymous concept in SNOMED CT.

The “MAPS-TO” connection is typically used to define a relationship between similar concepts existing in different bodies of knowledge, such as databases or terminological systems. For example, selected MAPS-TO relationships might link near synonymous concepts defined in SNOMED CT and ICD-9-CM. The MAPS-TO connection may also be used to identify a relationship where related concepts are linked (e.g., commonly related) to one or more ancestor nodes in a hierarchy.

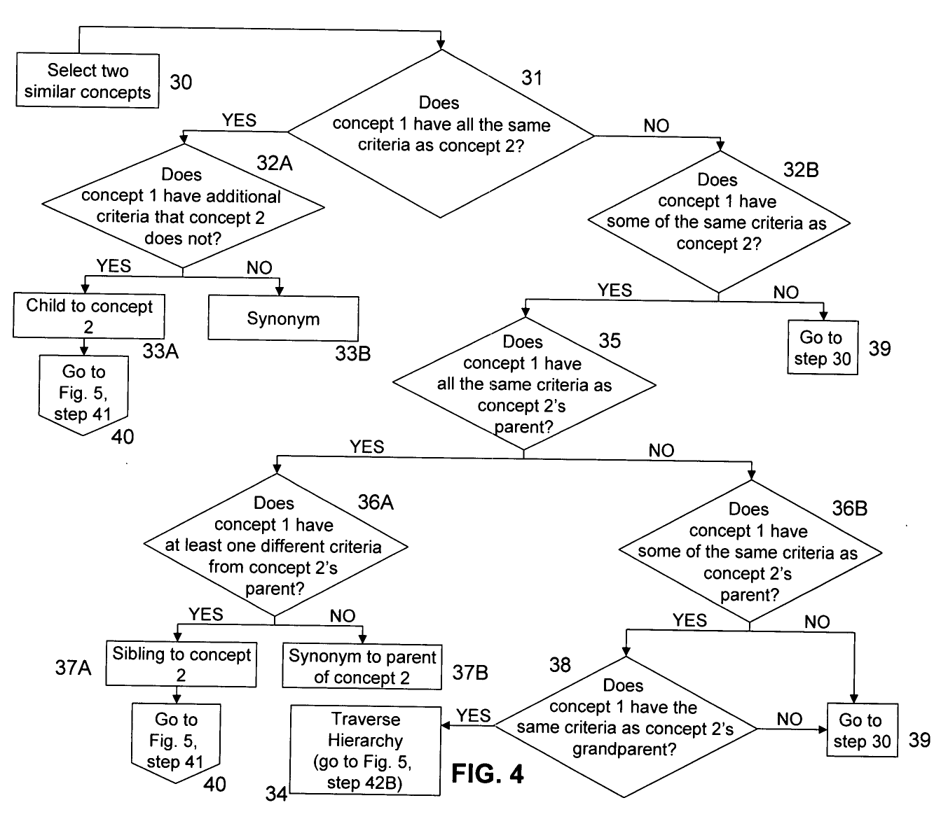

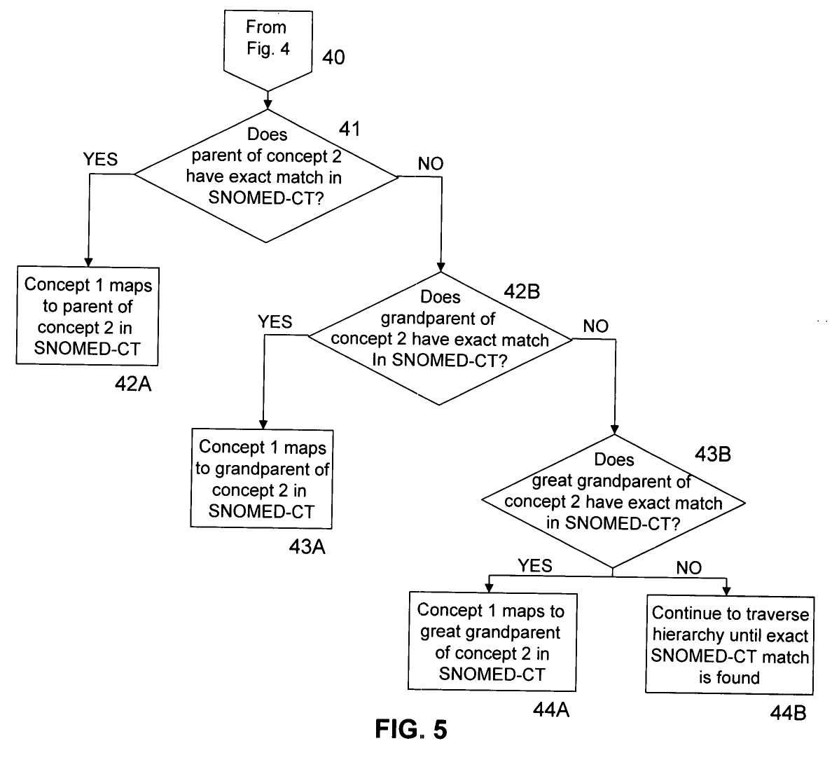

The HAS-EQUIVALENCE and MAPS-TO relationships are typically defined between concepts using matching and mapping procedures such as the ones shown in FIGS. 4 and 5, respectively. The flowchart of FIG. 4 illustrates an exemplary method for performing concept matching, (i.e. determining a degree of similarity between two concepts). In contrast, the flowchart of FIG. 5 illustrates an exemplary mapping procedure. Where the two concepts have a parent/child or a sibling relationship, a mapping procedure is used instead of a matching procedure.

Referring to FIG. 4, the exemplary method for performing concept matching comprises selecting first and second similar concepts (30) from the set of identified concepts. (Here, consistent with the working diabetes example, a first concept of “blood sugar level” and a second concept of “blood glucose measurement” might be selected). After identifying the two similar concepts, a determination is made as to whether the first concept has entirely common characterisitics (or criteria) with the second concept (31).

Where the first concept has entirely common characteristics with the second concept (31=YES), a determination is made as to whether the first concept has any additional criteria beyond those of the second concept (32A). Where the first concept has all the characteristics of the second concept and at least one additional characteristic (32A=YES), the first concept is determined to be a child concept of the second concept (33A), and hence the mapping procedure of FIG. 5 is invoked (40). However, where the first concept has all common but no other characteristics (32A=NO), the two concepts are considered synonyms to one another (33B).

In the event that the first concept doesn't have all common characteristics with the second concept (31=NO), a subsequent determination is made as to whether the first concept has some common characteristic with the second concept (32B). Where the answer to this determination is no (32B=NO), the method returns to step (30) and selects two similar concepts for matching (39). However, where the first and second concepts have some but not all similar characteristics (32B=YES), a subsequent determination is made as to whether the first concept has all of the same criteria as the second concept's parent (35).

Where the first concept has all of the characteristics associated with the second concept's parent (35=YES), a subsequent determination is made as to whether the first concept has at least one different criterion from the second concept's parent (36A). If the first concept has at least one characteristic different from the second concept's parent, (36A=YES), the first concept is considered a sibling to the second concept (37A) and the mapping procedure of FIG. 5 is invoked (40). However, if first concept has all common characteristics, yet no different characteristics with the second concept's parent (36A=NO), the first concept and the second concept are considered synonyms to one another (37B).

In the event that the first concept does not have all characteristics in common with the second concept's parent (35=NO), another determination is made as to whether the first concept has some of the same characteristics as the second concept's parent (36B). If the first concept has some characteristic in common with the second concept's parent (36B=YES), yet another determination is made as to whether the first concept has the same criteria as the second concept's grandparent (38). If the first concept has the same characteristics as the second concept's grandparent (38=YES), the method calls a subroutine that traverses the hierarchy (34) for information related to the grandparent of the second concept. Traversing the hierarchy may, for example, involve searching an ontology (e.g., an ontology comprising concepts from SNOMED-CT) for a match to the second concept's ancestors so that the first concept can be mapped onto that match (See, FIG. 5, 42B). However, if the first concept has no common characteristics with either the second concept's parent (36B=NO) or the second concept's grandparent (38=NO), the method returns to step (30) and selects two similar concepts.

Referring to FIG. 5, the exemplary method of mapping concepts comprises determining whether the first concept and the second concept's parent have a match in the ontology (41). Where this is the case (41=YES), the first concept maps to the second concept's parent in relation to the ontology (42A). However, where the first concept does not have a match in the ontology to the second concept's parent (41=NO), a subsequent determination is made as to whether the first concept and the second concept's grandparent have a match in the ontology (42B).

Where the first concept and the second concept's grandparent have a match (42B=YES), concept one is determined to map to the second concept's grandparent (43B). However, where the first concept and the second concept's grandparent do not have a match (42B=NO), a determination is made as to whether the grandparent of the second concept has an match with the first concept in the ontology (43B).

Where it is determined that the first concept and the second concept's great grandparent have a match in the ontology (43B=YES), the first concept is determined to map to the second concept's great grandparent in relation to the ontology (44A). However, where it is determined that the first concept and the second concept's great grandparent does not have an exact match in the ontology (43B), the process of traversing the hierarchy continues until a match is found (44B).

In addition to denoting exact matches between concepts, the term “match”, as used with respect to the exemplary mapping procedure, may also denote two concepts which are closely related to each other, e.g., terms which have a certain number of common characteristics.

The foregoing two flowcharts are simple examples of how relationships are defined or added between concepts in an ontology. In practical application, much more extensive hierarchies will be constructed and populated, and many types of relationships will be established between the concepts populating the hierarchy.

Before addressing issues related to the actual construction of a competent healthcare ontology, it should be noted that the processes of identifying and defining concepts (and concept relationships), will typically make use of one or more agreed upon conventions. So-called business rules, which include naming or designation conventions, are editorial policies which provide for a more coherent presentation and/or communication of information related to the healthcare ontology. For example, particular words, prefixes and the like may be generally associated with certain types of concepts or relationships (e.g., types of medications, diseases, etc). Similarly, a convention may define a particular use of punctuation, including hyphens, asterisks and the like, as well as font types and naming styles.

The fourth general step identified above in relation to the flowchart of FIG. 2, addresses the issue of ontology construction (13). The construction of a healthcare ontology will vary with purpose, design approach, concept and relationship definitions, and many other design choices. However, the construction of any competent ontology usually comprises selecting one or more ontology development tools (13A), including at least one extraction and analysis tool (13B).

Ontology development tools are typically implemented using one or more software applications running on a digital logic platform. These applications perform various tasks related to the creation of an ontology. The tasks typically include, for example, creating domain specific concepts, editing the concepts (e.g., adding terms and definitions to the concepts), modeling the concepts (e.g., define relationships between the concepts), moving the concepts (e.g., adding, deleting, or refining relationships within the concept hierarchy), importing other concepts (e.g., incorporating concepts from other relevant ontologies), visualizing (e.g., viewing specific concepts in a graphical format to assist in editing and modeling of the concepts), navigating (e.g., searching and finding concepts within the hierarchy), and mapping and matching (e.g. relating concepts from other imported ontologies to existing ones).

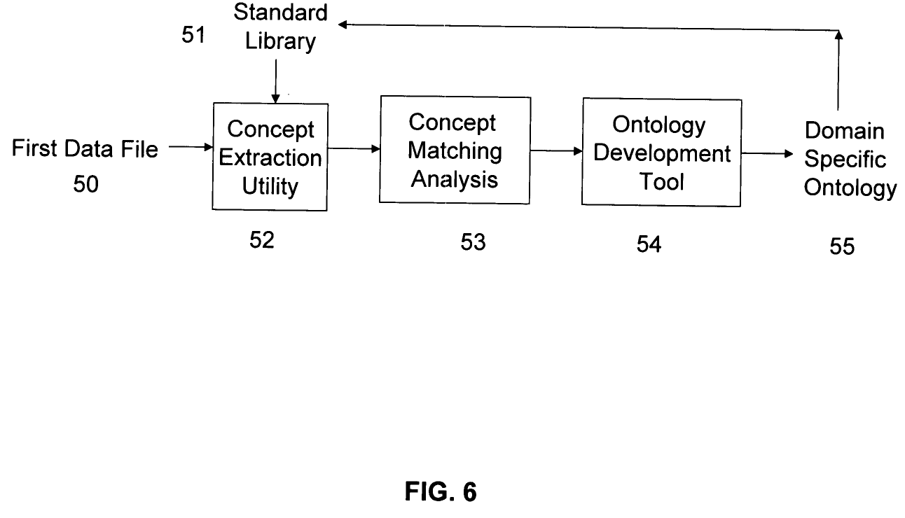

FIG. 6 is a conceptual diagram showing an exemplary system implementing a set of ontology development tools. The system assumes a first data file 50 (i.e., a source file) from an external source, and a standard library of related terms, and/or concepts 51. First data file 50, typically a text file, comprises a domain specific corpus of knowledge, such as a Merck Manual or Harrison's Principles of Internal Medicine, and standard library 51. Initially a standard library, which typically comprises a collection of standardized terminological systems, such as the Metathesaurus is used. The Metathesaurus, a component of the National Library of Medicine's (NLM) Unified Medical Language System (UMLS), is a very large multi-lingual compilation of over 100 terminological systems including, for example, SNOMED CT, RxNorm, and many others. As the ontology is built, newly identified concepts are added to the standard library.

In the exemplary system of FIG. 6, first data file 50 and standard library 51 are applied to a concept extraction utility 52 to produce a set of output concepts corresponding to first data file 50. Concept extraction utility 52 produces the output concepts by matching domain specific concepts contained in first data file 50 with concepts included in standard library 51.

As an example of how the output concepts are produced by concept extraction utility 52, suppose that first data file 50 comprises text taken from the Merck Manual of Diagnosis and Therapy related to Malnutrition, and that the text contains the sentence: “Undernutrition can result from inadequate intake; malabsorption; abnormal systemic loss of nutrients due to diarrhea, hemorrhage, renal failure, or excessive sweating; infection; or addiction to drugs.” Concept extraction utility 52 typically parses out concepts such as “undernutrition”, “inadequate intake”, “diarrhea”, etc. Then, it searches standard library 51 for concepts having a similar or identical connotation. Once identified in standard library 51, the concepts are output by concept extraction utility 52 along with a reference to the particular terminological system where each concept was found.

Concept matching analysis block 53 performs concept matching between the concepts output by concept extraction utility 52. For example, where the concepts output by concept extraction utility 52 include similar or synonymous concepts from different terminological systems, e.g. SNOMED CT and E&M codes, concept matching analysis block 53 forms a match or a particular relationship between the concepts. Concept matching analysis block 53 then outputs a terminology set including the concept matches and concept relationships.

The output of concept matching analysis element 53 is applied to an ontology development tool block 54, which further defines relationships between the concepts. For example, ontology development tool block 54 forms relationships such as “IS-A” relationships and “MAPS-TO” relationships between concepts. Ontology development tool block 54 then outputs a domain specific ontology 55 describing knowledge contained in first data file 50.

It should be noted that in order to define relationships and concepts using the above approach, each of elements 52, 53, and 54 may rely on natural language processing (NLP) tools and other conventional methods to make inferences and deductions about the information contained in the first data file. For instance, in the malnutrition example described above, ontology development block 54 may define a correlation or cause/effect relationship between the term “undernutrition”, and the terms “inadequate intake”, “malabsorption”, and “diarrhea” based on the linking phrase “can result from” in the input data file. In addition, terms or concepts in the first data file which do not correspond to any identified concept in standard library 51 may be included in domain specific ontology 55, such terms and concepts may be readily identified by the absence of a “HAS-EQUIVALENCE” relationship assigned thereto. It is the addition of these terms and concepts that enhance the richness and rigor of the ontology as compared to other terminological systems.

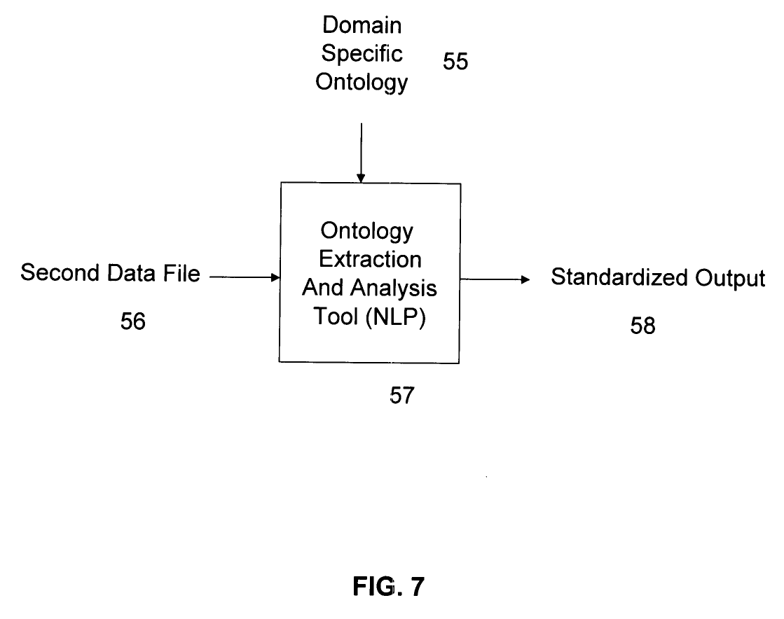

FIG. 7 shows an exemplary system using domain specific ontology 55 to produce standardized output 58 based on second data file 56. In this example, second data file 56 may be a corrected text file resulting from free-form verbal input from a healthcare professional, a text file related to a patient record, etc.

Referring to FIG. 7, ontology extraction and analysis tool 57 receives or accesses domain specific ontology 55 and second data file 56. Ontology extraction and analysis tool 57 typically uses NLP tools to extract concepts from second data file 56 and to map the concepts onto domain specific ontology 55. Then, the results contain the concepts and the mappings and are found in standardized output 58.

Some specific examples illustrating how information may be processed by the exemplary systems illustrated in FIGS. 6 and 7 will now be presented. In these examples, it will be assumed that wherever possible, domain specific ontology 55 and standardized output 58 contain mappings between concepts found in first and second data files 50 and 56 and billing codes contained in ICD-9-CM. In general, the billing codes can be provided apart from the ontology. However, for simplicity of explanation it is assumed that the billing codes are integrated into the ontology.

Some of the examples are illustrated in FIGS. 9 through 11, wherein arrows are used to show arbitrary linkages between various terms, concepts, and other elements of the exemplary systems. For example, arrows may be used to indicate relationships such as IS-A, MAPS-TO, and so forth. In some cases, the arrows are used to illustrate the order in which elements are considered during the course of processing the input. However, in the case of FIGS. 9 through 11 the arrows should not be taken to indicate a particular hierarchical relationship or a general direction of information flow.

As a first simple example, suppose that first and second data files 50 and 56 contain the concept “cleft lip”. Since the ontology and ICD-9-CM both contain the concept “cleft lip”, these concepts are readily extracted and matched in the formation of domain specific ontology 55, and as a result, ontology extraction and analysis tool 57 readily identifies the link between “cleft lip” in second data file 56 and a corresponding billing code in ICD-9-CM to generate standardized output 58.

The process whereby a billing code for the cleft lip example above is produced from second data file 56 is illustrated in FIG. 9. Referring to FIG. 9, the term “cleft lip” is provided as an input to ontology extraction and analysis tool 57 (91). The input is then matched with the corresponding concept “cleft lip” (92) found in domain specific ontology 55, which in turn is matched with a corresponding ICD-9-CM concept “cleft lip” (93) also found in domain specific ontology 55. The ICD-9-CM concept “cleft lip” has the property of billing code 749.1 (94), which is output by ontology extraction and analysis tool 57.

According to another example illustrated in FIG. 10, first and second data files 50 and 56 both contain the phrase “supraventricular tachycardia”. Although there is an exact match for this phrase in the ontology, there is no exact match in ICD-9-CM. However, ICD-9-CM contains a related concept “other specified cardiac dysrhythmias”, which has a billing code 427.89. Hence, the concept “supraventricular tachycardia” can be mapped to “other specified cardiac dysrhythmias” in order to create an output billing code.

The process whereby a billing code for the “supraventricular tachycardia” example above is produced from second data file 56 is illustrated in FIG. 10. Referring to FIG. 10, the term “supraventricular tachycardia” is provided as an input to ontology extraction and analysis tool 57 (101). The input is then matched with the corresponding concept “supraventricular tachycardia” (102) found in domain specific ontology 55, which in turn is mapped to a corresponding ICD-9-CM concept “other specified cardiac dysrhythmias” (103) also found in domain specific ontology 55. The ICD-9-CM concept “other specified dysrhythmias” has the property of billing code 427.89 (104), which is output by ontology extraction and analysis tool 57.

According to still another example, second data file 56 contains the phrase “PVC's”. If there is no match to “PVC's” in the ontology, “PVC's” can be normalized to “PVC”, which contains exact matches in the ontology. Normalization and other preprocessing procedures are usually carried out by concept extraction utility 52 and ontology extraction and analysis tool 57. Depending on the context, “PVC” could mean “polyvinyl chloride” or “premature ventricular contraction”. Assume the ontology contains three concepts with the string “PVC”: “unifocal PVC”, “multifocal PVC”, and “interpolated PVC”. None of these concepts have an ICD-9-CM match, but all three can be mapped to ICD-9-CM concept “other premature beats” with billing code 427.69. This particular mapping works in a case where the context of “PVC” indicates that it refers to “premature ventricular contractions”. However, where “PVC” is taken to mean “polyvinyl chloride”, a different mapping should be created.

In the case where “PVC” is taken to mean “polyvinyl chloride”, it may be associated with a variety of alternative medical conditions. For example, particular medical conditions are indicated by the phrases “PVC toxicity” and “PVC pneumoconiosis”. NLP tools are typically able to distinguish these types of phrases in input data. For example, upon parsing and normalizing the term “PVCs”, nearby text can be searched to detect related phrases such as “toxicity”, “pneumoconiosis”, and so forth.

Supposing that there is no match for the concept “PVC toxicity” in the ontology, additional processing can be performed to match or map this concept with a concept or concepts in domain specific ontology 55. For example, the phrase can be decomposed into its atomic concepts (individual words) and different variations of the atomic concepts including synonyms and related concepts can be combined to form potential matches or maps for concepts contained in the ontology. For instance, by decomposing “PVC toxicity” into “PVC” and “toxicity”, one can identify concepts similar to “PVC” such as “vinyl chloride” (i.e. PVC IS-A polymer of vinyl chloride), and “chlorinated hydrocarbon” (i.e. vinyl chloride IS-A chlorinated hydrocarbon). By combining these similar terms with “toxicity”, one finds that the concept “chlorinated hydrocarbon toxicity” is contained in the ontology. Although “chlorinated hydrocarbon toxicity” does not have an exact match in ICD-9-CM, it can be mapped to the similar ICD-9-CM concept “toxic effect of chlorinated hydrocarbons” which has a billing code 989.2.

The process whereby a billing code for the “PVC toxicity” example above is produced from second data file 56 is illustrated in FIG. 11. Referring to FIG. 11, the term “PVC toxicity” is provided as an input to ontology extraction and analysis tool 57 (111). The input is then decomposed and its atomic concepts are matched with corresponding ontology concepts “PVC” and “toxicity” (112). Through a series of linkages, the concepts “PVC” and “toxicity” are both related to a common ICD-9-CM concept “toxic effect of chlorinated hydrocarbons” found in domain specific ontology 55 (113). The ICD-9-CM concept “toxic effect of chlorinated hydrocarbons” has the property of billing code 989.2 (114), which is output by ontology extraction and analysis tool 57.

According to another example scenario, suppose that the terms “lung” or “pneumonia” are located in the text of the second data file near the term “PVC's”. The ontology concept “respiratory disorder”, which maps to ICD-9-CM term “unspecified disease of respiratory system” could be extracted from the ontology based on these terms, but not much else.

In order to provide more specific information about the condition described in the second data file, a healthcare professional can give feedback to the system. For example, where the healthcare professional notices the non-specific billing term “unspecified disease of the respiratory system” has been generated in the above scenario, the healthcare professional can amend the second data file to include the term “PVC pneumoconiosis”, which corresponds to the concept “pneumoconiosis” in the ontology, the latter being much more descriptive than “unspecified disease of the respiratory system”.

According to still another example, suppose the second data file contains the concept “heart attack”. “Heart attack” is a synonym of the concept “Myocardial infarction”, which in turn maps to the ICD-9-CM concept “acute myocardial infarction, unspecified site, episode of care unspecified” having billing code 410.90. In this case, the ontology concept is actually broader than the ICD-9-CM concept to which it was mapped. In other words, the relationship “acute myocardial infarction” IS-A “myocardial infarction” applies to these two concepts. In most cases, however, a concept is narrower than the concept to which it is mapped.

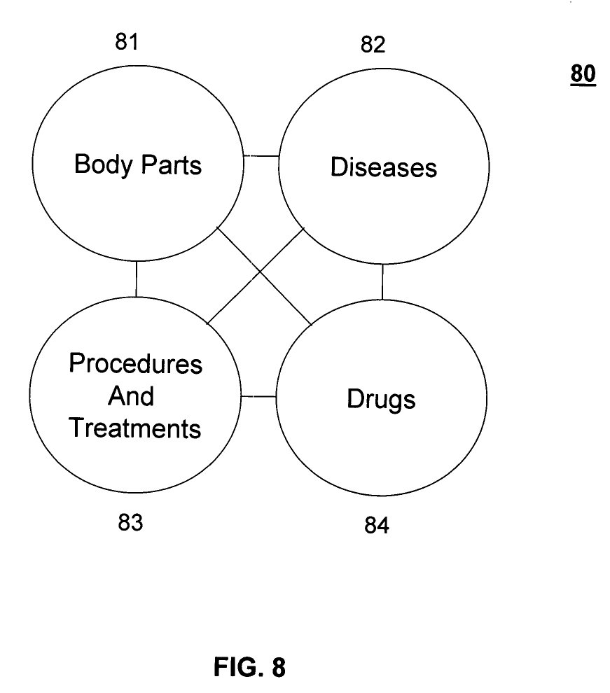

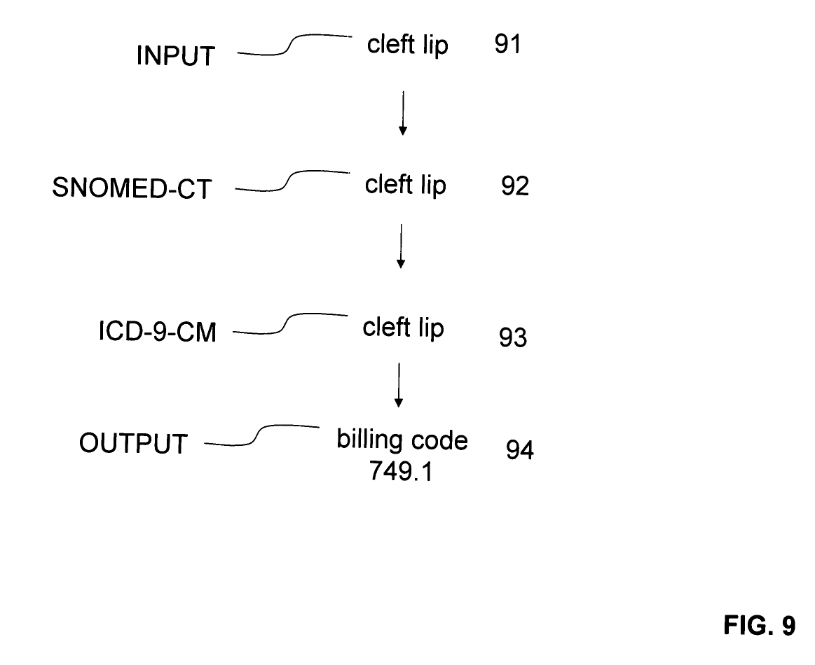

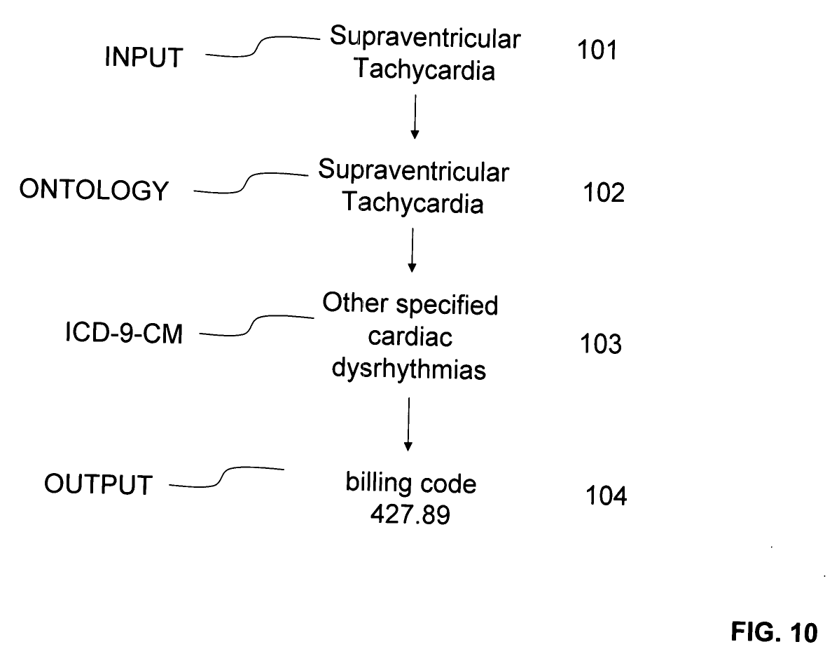

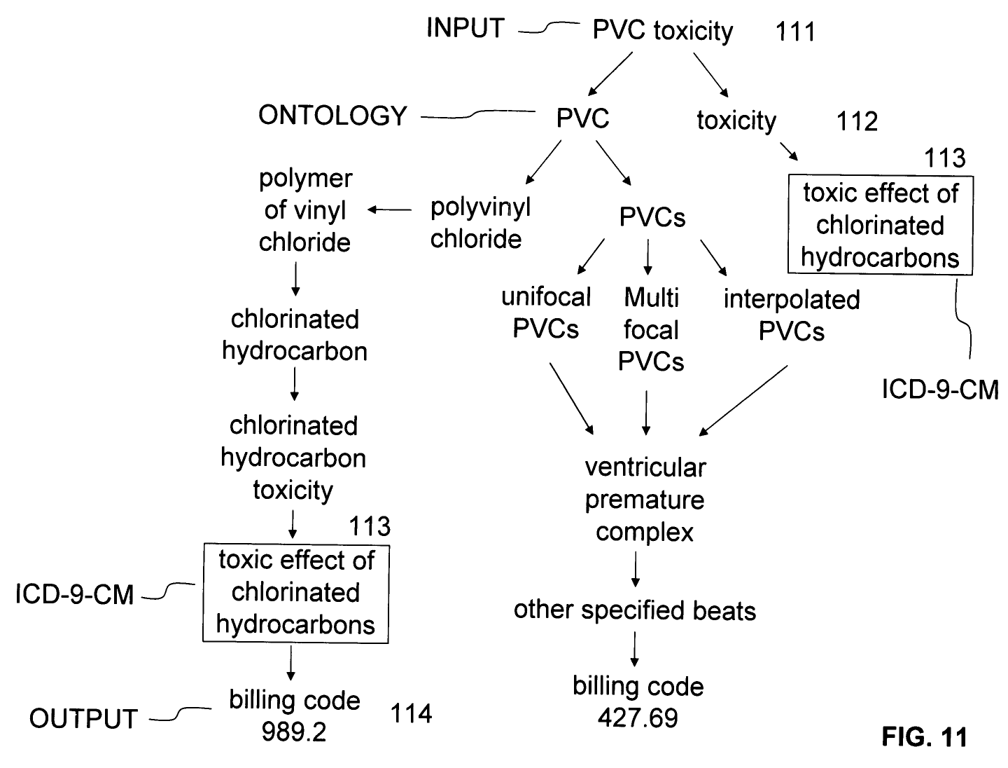

According to some embodiments of the invention, several ontologies may be linked together to form a composite ontology representing knowledge from a variety of domains. Consider, for example, the ontology shown in FIG. 8. Referring to FIG. 8, a healthcare ontology 80 comprises ontologies from four domains within the field of healthcare, including an ontology 81 describing various body parts and relationships between the body parts, an ontology 82 describing various diseases and relationships between the diseases, an ontology 83 describing procedures and treatments as well as relationships between the various procedures and treatments, and an ontology 84 describing various drugs and relationships between the drugs. Within healthcare ontology 80, there exist mappings, relationships, and other links between related concepts contained in the various domain specific ontologies. For example, while ontology 82 may contain a wealth of information about a disease such as diabetes, including body parts associated with the disease, drugs used to treat the disease, and so forth, other ontologies may provide other useful information. For example, ontology 81 may shed light on body parts that are secondarily related to diabetes, ontology 84 may contain information relative to drugs that may interact with drugs used to treat diabetes, and so forth.

Linking together multiple ontologies to form a composite ontology provides several benefits to both designers and users of the ontology. One benefit of linking together multiple ontologies is that it allows each ontology to be formed as an independent entity using a distinct standard library and a distinct first data file before being linked to other ontologies. By doing this, the search space for a particular domain of knowledge is limited to a controlled set of concepts, thereby eliminating several possibly ambiguous mappings for the input concepts. Likewise, where the composite ontology is used to process the second data file, certain phrases in the second data file can be used to indicate that a particular domain should be used for performing “first level processing” on the input while other domains should be used for “second level processing”. For example, where the second data file begins with the sentence “patient has pain in upper abdomen”, ontology 81 may be a good starting point for the processing of the second data file. Another way of saying this is that using a composite ontology provides multiple layers or scopes for processing concepts relative to the ontology; different scopes may be better adapted for processing different types of concepts.

As noted above with respect to the flowchart of FIG. 2, continued competence of a healthcare ontology requires some form of quality assurance and maintenance (14). Quality assurance and maintenance are conventional in nature and typically an ongoing set of tasks involving the verification of new or evolving concepts and relationships described in the ontology. That is, accurate update is required to maintain relevance of concepts and relationships in the healthcare ontology. In addition, quality assurance and maintenance processes serve to enrich valuable concepts and relationships while pruning away antiquated, irrelevant, or erroneous concepts and relationships.

What is claimed:

1. An information system, comprising:
a digital logic platform adapted to access a stored healthcare ontology linking concepts with at least one of the following standards: Systematized Nomenclature of Medicine Clinical Terms (SNOMED CT), Current Procedural Terminology (CPT), International Classification of Diseases, 9^{th} Revision, Clinical Modification (ICD-9-CM), Medical Subject Headings (MeSH), Logical Observations, Identifiers, Names, and Codes (LOINC), Computer Retrieval of Information on Scientific Projects (CRISP), Center for Disease Control and Prevention (CDC) web redesign thesaurus, Evaluation and Management (E&M) codes, Metathesaurus, and RxNorm, a standardized nomenclature for clinical drugs.

2. The information system of claim 1, wherein the concepts contained in the healthcare ontology are linked with an IS-A relationship and at least one relationship selected from a group of relationships including PART-OF, MAPS-TO, and HAS-EQUIVALENCE relationships.

3. The information system of claim 1, wherein the concepts contained in the healthcare ontology are linked with standard terminological systems using MAPS-TO or HAS-EQUIVALENCE relationships.

4. The information system of claim 1, wherein the concepts contained in the healthcare ontology are extracted from multiple source files using an automatic concept extraction procedure.

5. The information system of claim 4, wherein the automatic extraction procedure is supplemented with manual review.

6. The information system of claim 4, wherein the automatic concept extraction procedure comprises:
applying a first file received from an external source, and a standard library of related terms, and/or concepts to a concept extraction utility; and,
using the concept extraction utility to output concepts related to the first file.

7. The information system of claim 6, wherein the first file comprises a domain specific corpus of knowledge.

8. The information system of claim 7, wherein the domain specific corpus of knowledge comprises the Merck Manual or Harrison's Principles of Internal Medicine.

9. The information system of claim 6, wherein the standard library comprises a collection of standardized terminological systems.

10. The information system of claim 9, wherein the collection of standardized terminological systems comprises the Metathesaurus from the National Library of Medicine's (NLM) Unified Medical Language System (UMLS).

11. A method of forming a healthcare ontology, the method comprising:
extracting concepts from a file;
matching and mapping the concepts extracted from the file with concepts contained in a standard library; and,
performing concept modeling on the concepts extracted from the file, thereby establishing relationships between the concepts.

12. The method of claim 11, wherein concepts are extracted from the file using natural language processing (NLP).

13. The method of claim 11, wherein matching and/or mapping the concepts extracted from the file with concepts contained in the standard library comprises:
defining MAPS-TO and HAS-EQUIVALENCE relationships between the extracted concepts and the concepts contained in the standard library.

14. The method of claim 11, wherein the standard library comprises a collection of standardized terminological systems.

15. The method of claim 14, wherein the collection of standardized terminological systems initially comprises Metathesaurus from the National Library of Medicine's (NLM) Unified Medical Language System (UMLS).

16. The method of claim 15, wherein the input text comprises domain specific knowledge derived from a domain specific corpus such as a Merck Manual or Harrison's Principles of Internal Medicine.

17. The method of claim 11, wherein performing concept matching comprises:
selecting two similar concepts, including a first concept and a second concept; and,
determining whether the first and second concepts are synonyms.

18. The method of claim 17, wherein performing concept mapping comprises:
upon determining that the first and second concepts are not synonyms, traversing a concept hierarchy relative to the second concept to identify a concept closely related to the first concept.

19. A method of using a healthcare ontology, the method comprising:
receiving a domain specific ontology and a file;
extracting concepts from the file; and;
outputting a standardized representation for the concepts based on the domain specific ontology;
wherein the standardized representation comprises a structure indicating specific relationships between the concepts.

20. The method of claim 19, wherein the concepts are extracted from the file using natural language processing.

21. The method of claim 20, further comprising:
generating billing codes using the standardized representation.

22. A method of forming a healthcare ontology, the method comprising:
identifying a purpose for the healthcare ontology;
choosing a design approach for the healthcare ontology;
identifying concepts for the healthcare ontology and linking the healthcare ontology with at least one of the following standards: Systematized Nomenclature of Medicine Clinical Terms (SNOMED CT), Current Procedural Terminology (CPT), International Classification of Diseases, 9^{th} Revision, Clinical Modification (ICD-9-CM), Medical Subject Headings (MeSH), Logical Observations, Identifiers, Names, and Codes (LOINC), Computer Retrieval of Information on Scientific Projects (CRISP), Center for Disease Control and Prevention (CDC) web redesign thesaurus, Evaluation and Management (E&M) codes, and RxNorm, a standardized nomenclature for clinical drugs; and,
constructing the healthcare ontology.

23. The method of claim 22, further comprising periodically maintaining the healthcare ontology.

24. The method of claim 22, wherein the design approach chosen is a top-down design approach, a bottom-up approach, or a clustering design approach.

25. The method of claim 24, wherein any one of identifying the purpose of the healthcare ontology, identifying concepts for the healthcare ontology, or constructing the healthcare ontology is performed in relation to information provided by domain specific experts.
